(19) United States
(12) Patent Application Publication
(10) Pub. No.: US 2002/0059111 A1
(43) Pub. Date: May 16, 2002

(54) Method and system for placing and filling remote orders

(76) Inventors: Robert Jeffrey Ding, Athens, AL (US); Peter Luther, Toney, AL (US)

Correspondence Address: LARSON & TAYLOR, PLC, 1199 NORTH FAIRFAX STREET, SUITE 900, ALEXANDRIA, VA, 22314, US

(21) Appl. No.: 09/983,594

(22) Filed: Oct. 25, 2001

Related U.S. Application Data
(60) Provisional application No. 60/242,753, filed on Oct. 25, 2000.

(51) Int. Cl. G06F 17/60

(52) U.S. Cl. 705/26

(57) ABSTRACT

A method and system are provided for filling remote orders placed by customers. A customer location is identified where the customer is currently located and vendors close to the customer location are determined. A desired vendor request is received from the customer and placement of an order is facilitated from a customer directly to the desired vendor using a direct link. In one particular embodiment, the customer makes a delivery request to receive the prepared order using an identification tag to identify the previously placed order and subsequently the customer is provided with the order prepared using an automated delivery system.

### BACKGROUND OF THE INVENTION

1. Field of the Invention

The present invention relates to a method for filling orders, and in particular, a method for filling orders requested by a customer at a remote location.

2. Background of the Invention

Customers often wish to place orders for products or services with a desired, target vendor in advance of arriving at the location of the target vendor. If a customer wishes to purchase products and services from vendors within close proximity of where the customer is currently located, the customer needs to be aware of the vendor's proximate location. One conventional method for locating vendors within a particular area proximate the customer would be to browse through the Yellow Pages of a local telephone book. Once the customer determines a target vendor is available, the customer can then telephone the closest, or otherwise desired, target vendor location (if the target vendor has more than one location) and place an order with that desired target vendor assuming, of course, that the vendor accepts telephone orders.

A disadvantage with using this conventional method of locating vendors is that the customer must have access to a local telephone book. While this may not be a issue when a customer is calling from his or her home area, if a customer is on vacation or otherwise not in his or her home area, the customer may not have access to the local telephone book. In addition, regardless of whether the customer is in his or her home area or away, the customer may not necessarily know which target vendor is closest to where the customer is presently located.

A more sophisticated method for placing food orders is provided by the Internet service FOOD.COM which prompts a customer to enter his or her address and then provides the customer with a list of restaurants within a selected distance from the customer address. Next, the customer selects one of the restaurant from the list and then places his or her order with FOOD.COM. FOOD.COM charges the customer for his or her order and then subsequently relays the food order to the restaurant.

A disadvantage with FOOD.COM is that the customer must know where his or she is currently located in order to use the service. Of course, this may not be a problem in many instances but if, for example, the customer is away from home, and not sure of his or her exact location, the customer cannot use FOOD.COM. A further disadvantage of FOOD.COM is that this service is limited to food orders only.

A disadvantage of both conventional ordering methods as well as the FOOD.COM approach, is that the desired target vendor, e.g. the target restaurant, will normally fill the customer's order in the order received. For example, unless otherwise requested, an order placed first by one customer who is 20 minutes away from the desired target vendor will be filled first before a subsequent order placed by a second customer who is only five minutes away from the desired target vendor.

An additional disadvantage of the aforementioned ordering methods is that the customer may have to wait, once at the selected target vendor, in order to receive his or her order. For example, the customer may have to wait in line to pick up and/or pay for the previously placed order. Therefore, the customer may still experience a delay before receiving his or her order even though the order had been placed in advance.

### BRIEF SUMMARY OF THE INVENTION

In accordance with the present invention, a method is provided for filling orders placed by customers located remotely from a desired vendor. The order may be placed directly from the customer to a desired vendor via a direct link after the customer location has been identified and the customer is presented with a list of vendors close to the customer location. At the time of the ordering, the customer can make payment arrangements. Once the order is received by the desired vendor, the order is assigned an identification tag whereby the customer may pick up the order at the desired vendor using an automated delivery system.

The present invention, according to one aspect thereof, concerns a method for filling orders which comprises the steps of identifying a customer location where a customer is currently located in response to a general vendor request from the customer and determining vendors close to the customer location. A vendor listing based on the customer location is sent to the customer and a desired vendor request is received from the customer. Placement of an order is facilitated between the customer and the desired vendor via a direct link.

According to another aspect of the present invention, a method is provided for placing orders and filling orders placed by a customer which comprises the steps of sending a vendor request from a customer to an order control center and establishing a customer location at which the customer is currently located. The customer then receives a list of vendors close to the customer location. Subsequently the customer selects a desired vendor and places an order with the desired vendor. Next, the customer receives an identification tag corresponding to the order. The customer arrives at the desired vendor and receives the prepared order via an automated delivery system upon presenting the identification tag.

According to yet another aspect of the present invention, a method is provided for filling orders comprising the steps of identifying a customer location at which a customer is currently located in response to a vendor request and determining vendors close to the customer location. A remote order is received from a customer and the order is assigned an identification tag corresponding to the order. The order is prepared and a delivery request to receive the prepared order is made by the customer using the identification tag. The prepared order is then provided to the customer using an automated delivery system.

According to another aspect of the present invention, a system is provided for filling remote orders placed by customers. The system comprises an order control center, a receiving device and an automated delivery system. The order control center is for determining vendors close to the customer location, receiving a desired vendor request from the customer, and facilitating placement of an order from a customer to the desired vendor via a direct link between the customer and the desired vendor. The receiving device is for receiving remote order requests from customers and for assigning a respective identification tag corresponding to each order. The automated delivery system is adapted to receive a delivery request from customers using their respective identification tag and delivering the respective order corresponding to the respective identification tag to the respective customer.

An important advantage of one aspect of the present invention concerns substantially eliminating the delays associated with waiting for, paying for and receiving a previously placed order. In this regard, the automated delivery system of the present invention provides a customer with access to his or her order using a respective identification tag without having to wait to pay a clerk and/or having to wait to then receive the previously placed order.

A further important feature of one aspect of the present invention relates to providing a list of vendors to the customers that are in the proximity of the customer. An advantage of this feature is that the customer does not need to know which vendors are within close proximity nor which target vendor is closest to the present customer location or otherwise most convenient for the customer.

Further features and advantages of the present invention will be set forth in, or apparent from, the detailed description of preferred embodiments thereof which follows.

### BRIEF DESCRIPTION OF THE DRAWINGS

FIG. 1 is a flow chart depicting a method for filling orders according to a preferred embodiment of the present invention; and

FIG. 2 is a system for implementing the method of FIG. 1.

### DETAILED DESCRIPTION OF THE INVENTION

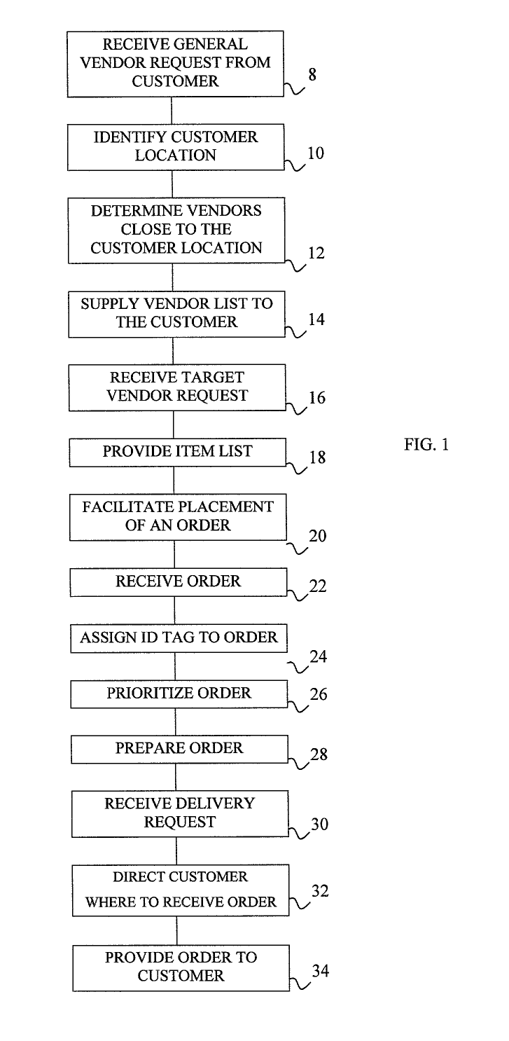

Referring now to FIG. 1, a flow chart is provided which depicts a preferred method for filling orders. As indicated in FIG. 1, as a first step, a customer initiates placement of an order by making a general vendor request, i.e., a request that the customer to be provided with a listing of vendors in the proximity of the customer (as indicated by block or step 8). In a preferred embodiment, this request is received by an order control center but alternative embodiments are discussed below. Subsequently, and in response to the general vendor request, a customer location is identified (step 10). Advantageously, the customer location is identified using a global positioning system (GPS) which provides for determining the location of a customer without the customer having to input his or her location and without the customer having to know exactly where he or she is presently located.

Optionally, instead of using the GPS, the customer location may be identified using alternative technologies. One such technology is the use of a cellular telephone or other wireless communication network to identify the customer location based on which antennas of a plurality of receiving antenna of the communication network receive a transmission sent by the customer when placing his or her order. For example, depending on which antennas receive the customer's signal and the relative strengths of the received signal, a general customer location is determinable using conventional methods.

Once the customer location is determined, all vendors within proximity of the customer location are determined (step 12) at the order central center which, e.g., maintains a database of such vendors. Herein, the term “vendor” includes both merchants and service providers (MSP). Subsequently, a vendor list is provided to the customer (step 14). The customer then selects a target vendor from the list of vendors provided (step 16). If there is more than one target vendor in proximity of the customer location, the customer may choose the closest vendor, or otherwise most desirable, target vendor. The customer is then provided with a list of items available from the desired vendor from which the customer can choose (step 18). Depending on the vendor, the items may include both products and services.

Next, placement of the order from the customer to the desired vendor is facilitated via a direct link between the customer and the desired vendor (step 20). The facilitation of order placement may include supplying the customer with a telephone number of the desired vendor, a radio frequency for direct radio communication with the desired vendor, or an Internet IP address which provides for a direct connection to the desired vendor, or providing the customer with any other method or information which, based thereon, provides for, or otherwise enables, a direct link between the customer and the desired vendor.

Subsequently, the customer places an order with the desired vendor using the direct link. As used herein, the term “order” may include a request for both products and services. Advantageously, at the time the order is placed, the customer arranges for payment of the order which includes providing the desired vendor with a credit card number or making other arrangements to pay for the order.

Alternatively, rather than using a direct link, customer orders can be relayed to the desired vendors by the order control center. In other words, the order control center receives orders from customers and then forwards those orders on to the respective vendors. The order control center can handle payment arrangements by the customer and appropriately credit the respective desired vendor.

The desired vendor receives the order from the customer (step 22) and each order is assigned an identification tag (step 24). Orders received by the desired vendor are then prioritized according to the time or distance a customer is from the selected vendor (step 26). Advantageously, the distance or time a customer is from the selected vendor is determined using the identified customer location. Optimally, if GPS is used to identify the customer location, the priority assigned to the order can be re-evaluated as the customer travels from one's customer location to the desired vendor. If a customer becomes detained and the order control center is notified of this, his or her order can be re-assigned a lower priority in an order queue.

As alluded to above, the orders are prepared in sequence according to their assigned priority (step 28). When the customer arrives at the desired vendor, the customer, using the identification tag, makes a delivery request to receive his or her order (step 30). The delivery request may be in the form of inputting (e.g., typing or speaking) the identification tag.

Next, the customer is directed where to go to pick up the prepared order (step 32) and subsequently, the prepared order is delivered to the customer using an automated delivery system (step 34). The automated delivery system will be described in more detail below.

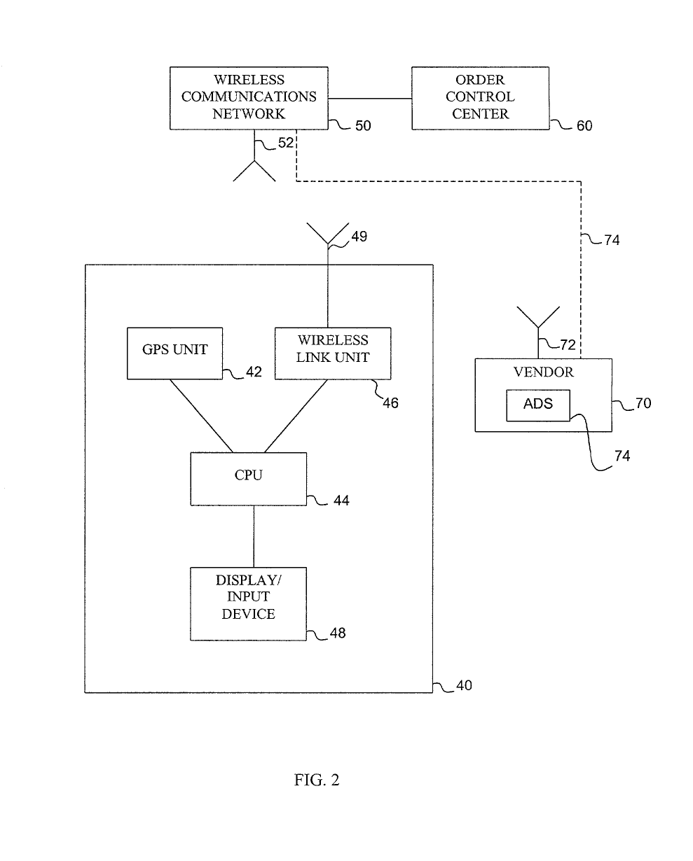

To provide further understanding of the present invention, reference is made to FIG. 2 which depicts a system in accordance with one preferred embodiment of the present invention. In this embodiment, a personal digital interface (PDI) 40 is used by a customer to place an order with a desired vendor. Advantageously, the PDI 40 is a handheld device but PDI 40 could be installed as a fixed unit in an automobile.

The PDI 40 preferably includes a Global Positioning System (GPS) unit 42 which provides for identifying the current position of the PDI 40. In addition, the PDI 40 includes a wireless link unit 46 which provides for the transmission of information to a wireless communication network 50 and possibly to a vendor 70. A display/input device 48 is employed which optimally comprises a graphical user interface (GUI) and may include a touch-sensitive screen input device.

In an alternative form, the PDi 40 does not include the GPS unit 42, and the location of the PDI 40 (and, therefore, the customer location) is determined using the wireless communication network 50. As indicated above, the wireless communication network 50 may comprise the technology of conventional cellular telephone networks which includes a plurality of receiving antennas 52 for receiving wireless transmission from a transmitting antenna 49. Depending on which of the receiving antennas 52 receive the transmission, the general location of the PDI 40, and therefore, the customer location, can be identified.

In a second, simplified alternative form, the PDI 40 does not include the GPS unit 42 and instead requires that the user manually identify his or her position or location. This position can be defined in many ways such as by providing information as to the state, city, zip code, area code, area code and prefix, street address, intersecting roads or streets, roads/street with mile marker, or significant landmark.

After the customer location is determined, the customer location is then sent to an order control center 60 by transmitting the customer location using wireless link unit 46. In one embodiment, the customer location is first received by wireless communication network 50 and is then sent to the order control center 60. However, if the wireless communication network 50 is used to identify the customer location, the customer location is then sent directly to the order control center 60.

Next, the order control center 60 determines vendors close to the customer location and provides a vendor list to the customer via the wireless communication network 50. The vendor list appears on the display/input device 48 from which the customer selects a desired vendor.

Using the display/input device 48, the customer selects a vendor and this selection is then sent using the wireless link unit 46 to the order control center 60 via the wireless communication network 50.

Subsequently, the customer is provided with an item list from which the customer may choose when placing his or her order. The item list may be provided by either the order control center 60 or directly from the selected vendor (for example, vendor 70). Direct communication between the vendor 70 and the PDI 40 will be discussed in detail below.

The order control center 60 subsequently facilitates direct communication between the PDI 40 and the desired vendor 70. In one preferred embodiment, the direct communication is direct two-way radio communication between transmitting antenna 49 and vendor receiving antenna 72 using a radio mode.

Alternatively, direct communication may be provided between the PDI 40 and the vendor 70 via the wireless communications network 50 using an alternative connection (denoted by broken line 74). The alternative connection 74 may include an Internet connection, a standard telephone connection, a cellular telephone connection or another wireless connection. What is relevant in this embodiment is that the direct communication between the PDI 40 and vendor 70 does not pass information through the order control center 60.

In an alternative to using a direct link between the PDI 40 and vendor 70, indirect communication may be used to place an order with the vendor 70. Using indirect communication, as first step, the customer order is sent from the PDI 40 to the order control center 60 via the wireless communication network 50. Subsequently, the order control center 60 forwards the order on to the vendor 70. In forwarding the order, the control center can use the wireless communication network 50, the Internet, telephone lines, or any other appropriate means of communication.

Next, the vendor 70 receives the order placed by the customer and assigns the order an identification tag and prioritizes the order as described above in steps 22 and 24 of FIG. 1. Once the customer arrives at the vendor, the customer uses an automated delivery system (ADS) 74 to receive the order previously placed. The ADS 74 can be adapted for drive-up or walk-up delivery of the completed order.

In a preferred embodiment, the ADS 74 comprises a self-service holding facility consisting of an array of compartments/lockers. Each completed order is placed into a compartment/cubicle. As necessary, the cubicle may be heated or cooled to preserve the contents of the order placed therein. When the customer arrives, the customer enters the identification tag via a keypad or other device of the ADS 74. Alternative devices for inputting the identification tag may include voice recognition, or placing the PDI 40 on or near a detection unit forming part of the ADS 74. Subsequently, the customer is provided with access to the appropriate cubicle and retrieves the order.

Alternatively, the ADS 74 may include a pick-up area where previously placed orders have been diverted following preparation by the vendor. In this embodiment, the customer enters the identification tag via a keypad or other device and the order is delivered automatically to the customer via a conveying system or hand delivery via a delivery person.

As will be apparent to those of ordinary skill, many features of the present method and system may be adapted to provide numerous goods and services. For example, the PDI 40 can be used to place take-out or eat-in orders with food vendors. In addition, the PDI 40 can be used to make a connection to various emergency facilities such as police, ambulance, medical centers, and emergency road service. The PDI can also display “trouble” information such as traffic congestion problems and alternative routes. In addition, the PDI 40 with GPS 42 can be used to track locations, distance traveled, and other parameters for detailed trip logging.

In further specific embodiments, the present method and system may be adapted specifically for use in prescription medication pick-up from pharmacies, movie rentals, car rentals, movie ticket ordering and purchases, hotel reservations, and grocery purchases.

The present method and system provide advantages to current ordering methods. For example, the present system provides a no-wait method for placing and filling an order. Once the customer arrives at the vendor, the previously placed order is available for pick-up using the identification tag without having to wait in line to pay and to receive the previously placed order. In addition, since the order is placed and can be confirmed, using the display/input device 48, there should be a decrease in the normal human error associated with conventional order filling processes and thereby increase the likelihood that the customer will receive his or her desired order correctly.

A further advantage of the present system is the ability to maximize the workforce/employees of the desired vendor. Using the present method and system, a business can avoid huge fluctuations in demand relative to ordering activity experienced in conventional methods where a customer must be on the premises to place an order. In businesses accepting phone orders, potential business is restricted by the number of phone attendants and/or the number of phone lines. However, since the present method does not require the need of telephone attendants in order for a customer to place an order, more orders can be potentially taken and there should be a reduction in, or elimination of, situations wherein a customer is put on hold while the orders of other customers are taken.

Although the invention has been described above in relation to preferred embodiments thereof, it will be understood by those skilled in the art that variations and modifications can be effected in these preferred embodiments without departing from the scope and spirit of the invention.

What is claimed is:

1. A method for filling orders, said method comprising the steps of:
identifying a customer location where a customer is currently located in response to a general vendor request from the customer;
determining vendors close to the customer location;
sending to the customer a vendor listing based on the customer location;
receiving a desired vendor request from the customer; and
facilitating placement of an order from a customer to the desired vendor via a direct link between the customer and the desired vendor.

2. The method of claim 1, wherein said step of identifying a customer location comprises using a global positioning system to determine the customer location.

3. The method of claim 1, wherein said step of identifying a customer location comprises using a wireless communication network to determine the customer location.

4. The method of claim 1, wherein said step of determining vendors close to the customer location is based on time or distance the customer is from the desired vendor.

5. The method of claim 1, further comprising the steps of:
receiving a plurality of orders; and
prioritizing the plurality of orders received according to one of time or distance that a respective customer is from the desired vendor.

6. The method of claim 1, wherein said facilitating placement of an order step comprises supplying the customer with one of a telephone number, radio frequency and Internet IP address of the desired vendor so as to provide the direct link between the customer and the desired vendor.

7. The method of claim 1, further comprising the steps of:
receiving a remote order by the desired vendor from the customer;
assigning an identification tag corresponding to the order;
preparing the order;
receiving a delivery request to receive the prepared order by the customer using the identification tag; and
providing the order to the customer using an automated delivery system.

8. The method of claim 7, wherein said providing the order to the customer comprises locating the order in a compartment accessible via the identification tag.

9. The method of claim 7, wherein said providing the order to the customer comprises transporting the order to the customer using the automated delivery system.

10. A method for placing orders and filling orders placed by a customer, said method comprising the steps of:
sending a vendor request from a customer to an order control center;
establishing a customer location at which the customer is currently located;
receiving by the customer of a list of vendors close to the customer location;
selecting a desired vendor by the customer;
placing an order by the customer with the desired vendor;
receiving by the customer of an identification tag corresponding to the order; and
after arrival of the customer at the desired vendor, receiving by the customer of the order via an automated delivery system upon presenting the identification tag.

11. The method of claim 10, wherein said step of establishing a customer location comprises using a global positioning system to determine the customer location.

12. The method of claim 10, wherein said step of establishing a customer location comprises using a wireless communication network to determine the customer location.

13. A method for filling orders, said method comprising the steps of:
identifying a customer location at which a customer is currently located in response to a general vendor request;
determining vendors close to the customer location;
sending to the customer a vendor listing based on the customer location;
receiving a desired vendor request from the customer;
receiving by the desired vendor a remote order placed by the customer;
assigning an identification tag corresponding to the order;
preparing the order;
receiving a delivery request to receive the prepared order by the customer using the identification tag; and
providing the order to the customer using an automated delivery system.

14. A system for filling remote orders placed by customers, said system comprising:
an order control center for determining vendors close to a customer location, for receiving a desired vendor request from a customer at the customer location and for facilitating placement of an order from the customer to the desired vendor via a direct link between the customer and the desired vendor;
a receiving device for receiving remote order requests from customers and for assigning a respective identification tag corresponding to each order; and
an automated delivery system adapted to receive a delivery request from customers using the respective identification tag of the customer and for delivering the respective order corresponding to the respective identification tag to the respective customer.

15. The system of claim 14, further comprising an automatic location system to identify where the customer is currently located.

16. The system of claim 15, wherein said automatic location system comprises a global positioning system.

17. The system of claim 15, wherein said automatic location system comprises a wireless communication network.

18. The system of claim 14, wherein said automatic delivery system comprises a plurality of compartments, each compartment being accessible via use of one of the respective identification tags.

19. The system of claim 14, wherein said automatic delivery system comprises a conveying system for transporting the order to the customer.
